(19) United States
(12) Patent Application Publication
(10) Pub. No.: US 2011/0048411 A1
(43) Pub. Date: Mar. 3, 2011

(54) PRISMATIC LENS

(75) Inventor: Nicholas Simon Walker, Swindon (GB)

(73) Assignee: MICROSHARP CORPORATION LIMITED, Swindon (GB)

(21) Appl. No.: 12/919,540

(22) PCT Filed: Feb. 23, 2009
(86) PCT No.: PCT/GB2009/000487

§ 371 Date: Nov. 8, 2010

(30) Foreign Application Priority Data
Feb. 26, 2008 (GB) 0803551.1

(51) Int. Cl. F24J 2/08; G02B 3/08; B32B 38/04; B32B 37/16

(52) U.S. Cl. 126/698; 359/742; 359/743; 156/258; 156/242

(57) ABSTRACT

A point focus thin film Fresnel lens (15; 25) has an inner, substantially flat region (8; 22), and an outer region (9; 23), the outer region projecting outwardly from the inner region and at a substantial angle away from the plane of the inner region. In one embodiment the lens is in the form of a truncated cone (15) with a circular inner region as its apex, hi another embodiment the lens is in the form of a dome (25) and the outer region is formed by joining together segments (23) extending radially from a circular central region (22).

This invention relates to prismatic (Fresnel) lenses.

Fresnel optical lenses are important in a range of applications. One important area is solar concentrators. These are used in such applications as solar powered electricity generation using photovoltaic cells or solar thermal heating, and also daylighting in which for example the Fresnel lens captures light that is passed through a reflective tube to a room of a building. Fresnel prism lenses are a common component of such solar concentrator systems. Generally the lenses have a few large facets and are relatively thick. To make such lenses casting, e.g. injection moulding, or hot embossing is required.

Fresnel lenses may be flat or of a curved convex type. A typical domed, or part-spherical, Fresnel lens is designed to focus on a point, and a typical part-cylindrical Fresnel lens is designed to focus on a line. U.S. Pat. No. 6,111,190 discloses both such arrangements in the context of a solar concentrator for space satellite power systems.

It is known to manufacture Fresnel lenses from thin film. This is advantageous since it is still possible to offer high quality optics but manufacturing costs are reduced. Manufacturing uses a continuous roll-to-roll process and smaller quantities of plastic materials. However, a factor is that the total number of facets increases as the depth of the structures are reduced, and this generally results in worse performance, exacerbating problems that are inherent in Fresnel lenses.

The efficiency of light transmission to a target area falls off away from the centre of a Fresnel lens. This partly due to Fresnel losses—as the angle the light has to be deflected increases, the angle of the Fresnel prisms increases and the losses due to reflectance at the interface with a prism increase also. In addition light is lost from the area where one facet transitions to another due to light scattered by interacting with the non-optical facet of the prism and due to scattering at the peaks and/or valleys of the prisms, which are not perfectly shaped. Since there are more facets in the outer part of the lens this effect is greater there. Finally the prisms have sharper angles towards the edge of the lens and the cutting tools cannot form as good peaks/valleys of the prisms in this part of the lens, again resulting in greater light losses due to a diffusive lens action of the increasingly rounded peaks/valleys.

Such problems can be reduced if the Fresnel is of the curved convex type. Although this increases the reflectance from the front of the lens, thereby decreasing the efficiency of that part of the lens, it decreases the Fresnel losses from the back. This is due to a reduction in the turning angle required; since the light does not meet the Fresnel prism at such an acute angle, the Fresnel reflectance losses at this interface are reduced. A further advantage of a curved convex type of Fresnel lens is the reduction in the difference between the turning angles for light of different wavelengths, i.e. lens chromatic aberration. For a typical lens material such as acrylic plastic, red light has an effective refractive index of around 1.48 while blue light has an effective refractive index of around 1.51. The curvature of the surface so that it is not orthogonal to the incident light, results in some refraction at the front surface, which serves to at least partially compensate for the chromatic aberration at the Fresnel prisms, thereby allowing a smaller target area and therefore better overall concentration ratios for the lens. Finally, light is lost where the light interacts with the vertical, non-optical facet and with the apices of the prism which may be curved or otherwise show optical defects. By curving the surface, the light passes through the lens at an angle which can be used to keep the light away from the non-optical facet and the peaks of the prisms.

The manufacturing technique for a curved Fresnel lenses of a conventional type would typically involve precision injection moulded parts, but that is not applicable to thin film lenses.

One aspect of the present invention concerns a thin film Fresnel lens with improved performance over a flat thin film Fresnel lens, but which is practical to manufacture.

Thus, viewed from one aspect there is provided a point focus thin film Fresnel lens having an inner, substantially flat region with lens facets, and an outer region with lens facets, the outer region projecting outwardly from the inner region and at a substantial angle inclined away from the plane of the inner region.

In one preferred arrangement, the outer region extends in a linear fashion at a constant angle away from the inner region, so that the lens has the form of a truncated cone. Alternatively, the outer region could extend in a curved fashion away from the inner region, with monotonically increasing angles so that the lens has the form of a flat bottomed dish, for example. Using a plurality of linearly extending portions with increasing angles away from the plane of the inner region, can approximate the profile of a curved region. When using a curved region, the radius of curvature is preferably constant but it could vary, for example the surface angles could be optimised to maximise the lens efficiency. There could be hybrid arrangements, with one or more linearly extending portions and one or more curved portions, arranged in a radial direction.

Using a linearly extending outer region with a single angle of slope, means that the efficiency of the outer region cannot be fully optimised. However, there will be an overall optimisation of the complete lens including the inner region. In addition, manufacture is not complex. A curved outer region can be, or approximate to, part of a substantially spherical surface so as to improve the efficiency of all the edge parts of the lens, but is more complex to manufacture.

The outer region preferably extends at least partly around the inner region. Preferably, the outer region extends substantially completely around the inner region. The radial extent of the outer region can be substantially constant. However, other arrangements are possible. For example, the film could have a polygonal shape, such as square, hexagonal or with any desired number of sides, or a star shape, and corners portions (which would be portions adjacent the “points” in the case of a star configuration) could then be bent away from the plane of the central region of the polygon so that there is a discontinuous outer region, with the radial extent of the outer region decreasing and then increasing between any two adjacent corners. For example, such an arrangement could involve a flat square with four portions, the corners, which are bent away from the plane of the central portion, or an eight pointed flat star with the eight points bent. Obviously, the portions will all be bent in the same sense with respect to the plane of the inner region.

Such an arrangement, using a polygon or star with bent corner portions, will improve the efficiency of the furthest out parts of the lens, which are those parts of a flat point focus Fresnel lenses where efficiency falls off considerably. Structures of this type can be easily manufactured as flat film. Mounting may require some additional effort but will still be relatively simple, particularly in the case of a turned down four corner structure. There will be a minimum of film wastage if using square with turned down corners, as the squares can readily be tiled on the original continuous film.

There are some drawbacks with such a system, though. The area of the lens presented to the sun in solar concentrator applications will be reduced compared to the equivalent flat square. If the radial fixed prismatic profile is cut, i.e. the prismatic profile is circularly symmetrical—which is likely to be the case—then the light focus will be spread since the turned down sections do not have the correct curvature profile in both directions of curvature. More complex approaches, modifying the prismatic profile around the lens to compensate for this, would be very more complex and costly to manufacture.

The film formed from a conical outer region will have the correct circular curvature, since the film remains flat in a direction outwards from the lens centre.

In the case of a truncated cone, if the starting material is a circle of film then the base of the cone will be level and continuous. If initially the film is a square and is formed into a truncated cone in the same way, then the base of the cone will not be level but will have four points.

A lens in the form of a truncated cone may be assembled from two parts, namely a circular inner lens region which forms the truncated top of the cone, and an outer lens region having two ends, the outer lens region extending around and being joined to the periphery of the inner lens region, and the two ends of the outer lens region being joined together. The outer lens region forms the body of the cone.

The outer lens region can be in the form of a split annulus. In that case, the starting material could be a circle of the lens film. The circular inner lens region can be defined by an annular slot, and the annular outer lens region split by means of two radially directed cuts defining a portion which is removed, so that when the two ends are joined together the body of the cone is formed.

In an alternative arrangement, the outer lens region can be such that when the ends are joined together, the profile is polygonal in plan view, such as square. In such as case the starting material would be, for example, a deformed square of the film. This is then provided with an annular slot defining the inner region, and the outer lens region is split by means of two radially directed cuts defining a portion which is removed, so that when the two ends are joined together the body of the cone is formed.

A truncated cone arrangement improves the efficiency of all of the outer parts of the lens and enables a significant part of the lens film to have light kept away from the prism apex, resulting in better performance. A master mould is manufactured relatively easily, as a modification of a conventional flat film Fresnel structure as is familiar to those skilled in the art. There is only one join line in the outer lens region, as well as a circular join line between the inner and outer regions. The joins may be provided by welding, bonding or the like, or the portions may for example be placed in a laminated holder.

In a similar fashion, a lens with a curved outer region, providing a dome shape, may be assembled from two parts, namely a circular inner region joined to a curved outer region which are joined together by suitable means. In a preferred arrangement, however, the outer region is integral with the inner region. This can be achieved by making a series of cuts in a circular film, the cuts extending radially outwards from the circular periphery of the inner region. The cuts are such as to define a plurality of film segments separated by gaps. The gaps between adjacent film segments are then closed up, forming the curved outer region. There may, for example, be sixteen film segments. The segments may be joined together directly by welding, bonding or the like, or the portions may for example be placed in a laminated holder and adhesive used.

In such arrangement, the multiple join lines between adjacent film segments will reduce efficiency somewhat and the target focus will be spread due to the segmented nature of the lens (that is each segment fails to achieve the correct curvature in the direction around the lens). Whilst increasing the number of segments reduces the spread of the light focus, its effects on reducing efficiency and complexity through the increase in the number of seams is less beneficial. For these reasons, and the increasing complexity of manufacture, the number of films segments should not be too great.

With lenses formed from circular pieces of film, there will some wastage when cutting the circles out of a film sheet. In the case of the truncated cone, there will also be wastage in terms of the annular gap between the circular inner region and the outer region, as well as material removed from the outer region to enable the dome structure to be achieved. In the case of a domed outer region formed from segments, there will be the wasted material removed from the film, between each segment.

In the case of a truncated cone, the circumferential join between the inner region and the outer region, and the join between the ends of the outer region, are displaced from the centre of the lens and start at the radial extent of the circular inner region. In the case of a curved outer region made from segments, in a preferred arrangement there is no seam between the inner and outer regions, and the joins between adjacent segments terminate at the boundary of the inner region, away from the centre of the lens.

The inner region of the lens need not be perfectly flat. Indeed, in accordance with another aspect of the invention the invention the inner region could be domed but to have a lesser degree of inclination or radius curvature than the outer region. For example, a circular inner region could be formed into a shallow cone by providing a relatively narrow radial slot and joining the ends together. The outer region could then be the body of a truncated cone or curved, in the manner discussed above, and joined to the central region. In general, it is preferred that the central region is substantially flat, or has an angle of inclination or a radius of curvature which is provides substantially less of a conical or curved effect than is provided by the outer region. It is also preferred that there are no seam lines within the central region.

The relative proportions and sizes of the inner and outer regions will depend on the overall size of the concentrator lens and the designed focal length of the lens. The transition from the inclined outer elements to the flat inner element is placed where required in the design—for example in the conical outer region arrangement, the transition must occur where the bottom angle of the Fresnel prisms reaches 90° and the angle of light passing within the prism is the same as the angle of light exiting from the prism. If the conical surface was extended further inwards towards the centre of the lens then the light passing through the prisms and also exiting from the prisms would interact with the non-optical facet of the prisms and this would result in a loss of efficiency.

In some preferred embodiments, the inner region is circular with a minimum radius of about 14% to about 15% of the radius of the whole lens and a maximum radius of about 55% to about 60% of the radius of the whole lens, and preferably has a radius in the range of about 25% to about 45% of the radius of the whole lens, and more preferably between about 28% to 29% and about 35% to about 36%. In some preferred embodiments the inner region has a minimum radius of about 1/7 of the radius of the whole lens and a maximum radius of about 4/7 of radius of the whole lens, and more preferably between about 2/7 and about 3/7. In some embodiments the radius of the inner region is between about 2/7 and about 5/14, or between about 2/7 and about 3/7. It has been found that for the flat circular Fresnel lens of the inner region, the efficiency of this region deteriorates significantly for radius values which are much greater than about 28% to about 29%, or about 2/7, of the whole lens radius, the actual value depending on the focal length of the lens and the quality of manufacturing.

In some typical applications, the inner region is circular with a minimum radius of about 1 cm and a maximum radius of about 4 cm, and more preferably about 3 cm, or about 2.5 cm or about 2 cm. In some embodiments, the radius of the inner region may be between about 1.5 cm and about 3 cm, and for example between about 1.5 cm and about 2.5 cm. In some embodiments the radius of the inner region is between about 2 cm and about 2.5 cm, or between about 2 cm and about 3 cm. A typical overall lens radius in such applications may be between about 5 cm to about 10 cm, and perhaps in the region of about 7 cm.

In the case of a linear outer region, such as when the lens is in the form of a truncated cone, it has been found that the angle of inclination away from the plane of the inner region, affects the lens efficiency. As the angle of inclination increases the efficiency of the outer inclined parts of the lens are improved as the angle of inclination better matches their optimal angle. For inner inclined parts of the lens the efficiency decreases as it less matches the optimal value.

Another effect of increasing the angle of inclination is to increase the size of the inner flat lens region that is required. This is because the transition from the inclined to the flat region occurs when the alpha angle on the conical section equals the angle of the light within the prism and the exit angle of the light from the prism—the alpha facet is “squeezed out”. The higher the angle of inclination the larger the radius of the flat lens region that results. It has been found that for lens of the same focal length, but different angles of inclination, the overall lens light transmission efficiency increases slowly to around 20° and then increases significantly between about 20° and about 25° and then increase slowly further to about 30° at which point the efficiency values flatten out. Preferably, therefore, the parameters of the lens are chosen such that the angle of inclination is between about 20° and about 40°, or for example between about 22° and about 35°, or between about 22° and about 30°, or between about 25° and about 35°, or between 25° and about 30°, and in some typical applications about 25°; whilst the radius of the inner lens region is in the ranges discussed earlier and for example between about 2/7 and about 3/7 of the entire lens radius (depending on the precise focal length of the lens). For example, with a lens designed to have a lens radius of about 7 cm, and a focal length of about 14 cm the radius of the inner flat lens region would be about 2.4 cm if the angle of inclination is about 25°.

The concentrating ability of the edge prisms also varies as a function of the angle of inclination and the focal length. It has been found that up to, for example, a lens inclination angle of 40° increasing the inclination angle increases the concentrating ability, as chromatic aberration is compensated for to some degree. It also reduces the focal length at which maximum concentrating ability is shown. For an angle of inclination of between about 25° to about 35°, it has been found that a concentrating ability in excess of 100 can be provided with a focal length ratio minimum ranging from about 2.5 down to about 1.8. In this specification the expression “focal length ratio” denotes the ratio of the focal length of the lens (with the base of the lens taken to be the lowest point on the lens optical structure) to the overall radius of the lens, so that for example if a lens has a radius of 7 cm and a focal length of 14 cm, the focal length ration is 2. It will be appreciated that the radius of the lens refers to the effective radius over which focussing takes place.

It has been found that the efficiency of the prisms in the outer region also varies in dependence on the angle of inclination and the focal length. For an angle of inclination of between about 25° to about 35°, it has been found that a light transmission efficiency of the lens of above about 0.9 can be provided with a minimum focal length ratio ranging from about 1.5 to about 2.5 cm.

For the flat inner region of the lens, it has been found that maximum efficiency can be approached with a focal length ratio of about 3, and that the efficiency decreases significantly for focal length ratios below about 2.

Several factors are important in deciding on the optimal focal length for the lens. Where use is to be in the context of a solar concentrator, the focal length should be as short as possible in order to reduce the depth of the solar concentrator assembly “box”, and to reduce the effect of small angular errors on the emerging light or on the position of the target, or associated with vibrations in the concentrator. On the other hand it should be as long as possible in order to increase the efficiency of the lens, to increase the bottom angles of the prism and therefore ensure that the prism apices are manufactured to better precision and therefore less light is lost, and to lower the angle of the prisms, make them wider and therefore reduce the number of facets in the lens. The focal length should be optimised to enable adequate levels of concentration from the prism at the edge of the lens. In addition, and as noted earlier, for a truncated cone lens, as the focal length increases, the proportion of the lens consisting of the inner flat region increases. Since the prism apices and non-optical facets can be hidden in the inclined part but not the flat part, in general this will lower the efficiency of the lens.

All this means that there will be an optimal, intermediate focal length for the lens. In general the theoretical efficiency of a lens in accordance with the invention, taken as the front surface and back surface reflectance losses, with no account being taken for facet and apex losses, increases with increasing focal length and there is a significant reduction in efficiency if the focal length ratio is below about 2.

As the focal length is increased, the number of facets within the central flat region increases, simply because the size of the flat region increases (the outer edge prism number remains approximately the same or reduce). Essentially the same flat Fresnel design is expanded as the focal length increases, and the area of conical lens decreases to compensate. To minimise the number of flat inner region Fresnel facets/apices, the focal length ratio should therefore be kept to a minimum. In general it is found that overall a focal length ratio of about 2 provides a suitable compromise in terms of the prism count.

Thus, in some preferred embodiments of the invention using a truncated cone shape, the flat central region has a radius of about 2/7 to about 3/7 of the total lens radius (depending on the precise design—focal length and inclination angle of outer section), the inclination angle of the outer region is about 25°, and the focal length ratio is about 2. In a typical photovoltaic concentrator system, a lens with these parameters could have an overall radius of from about 5 cm to about 10 cm, and typically about 7 cm. This would typically be formed in a manner which results in a square cross section to the light enabling these lenses to be tiled into a module.

The invention also extends to a method of manufacturing a lens, wherein a portion of thin Fresnel lens film is provided with an annular cut to define a circular inner region separated from an outer region, an inwardly tapering cut is provided from the periphery of the outer region to the annular cut, the sides of the inwardly tapering cut are joined to together to form the wall of a truncated cone, and the outer region is joined to the inner region whereby the inner region forms the apex of the truncated cone.

The invention also extends to a method of manufacturing a lens, wherein a circular portion of thin Fresnel lens film is provided with a plurality of circumferentially spaced cut outs extending from the periphery of a circular inner region to the periphery of the film portion, the cut outs tapering inwardly from the periphery of the film portion to the periphery of the central region and defining radially extending film segments, and adjacent segments are joined together along their edges so that the segments define an outer region which extends around the entire inner region and which projects in a curved fashion away from the plane of the inner region.

The invention also extends to a method of making a lens, wherein a portion of thin Fresnel lens film has a polygonal shape, and corners portions are bent away from the plane of the polygon to provided outer regions which extend at an angle away from the plane of an inner region defined by the remainder of the film portion.

In accordance with an alternative aspect of the invention, a thin film Fresnel lens is curved in one direction, so that it follows at least substantially the surface of a cylinder, and the facets are arranged so that the lens focuses to a point rather than to a line as is the case with a conventional cylindrical lens. This will improve the efficiency of some outer parts of the lens, though not all. Such an arrangement is relatively easy in terms of manufacturing the lens in the curved shape, and the lens can be mounted in a frame with little or no wastage. However, care has to be taken in terms of designing and cutting the radial angle varying facets.

In accordance with another aspect of the invention there is no central flat region and the lens is in the form of a cone with a relatively sharp apex. The sides of such a cone could be straight as discussed above, or could be curved.

In accordance with all aspects of the invention, the optical elements of the lens are conveniently manufactured using a low cost roll-to-roll manufacturing technique, such as UV casting. Films manufactured using these techniques are generally manufactured on a thin substrate, such as 75 to 300 micron thick PMMA. Such thin lenses may not have the robustness necessary to withstand physical impacts such as from hail or other sources. In addition the Applicant has recognised that seams in the film resulting from its assembly mean the lens may not be sealed against water ingress which can lead to the lens being weather-damaged.

In accordance with all aspects of the invention, the Fresnel lens is preferably provided with a transparent protective layer over the convex face of the lens. In this way the lens can be sealed and protected from being damaged, e.g. by the weather.

The protective layer preferably comprises a continuous transparent plastic sheet, for example a PMMA sheet. This allows light to pass through the layer and therefore does not adversely affect the transmission efficiency of the lens.

Preferably the protective layer is thicker than the thickness of the thin film Fresnel lens. An example of a suitable range of thicknesses is 1-3 mm. This allows it to act as a mount for the lens and so makes the lens more robust against damage.

The protective layer could be planar, but preferably it conforms to the shape of the lens, e.g. frusto-conical as disclosed elsewhere herein. This improves light transmission into the lens.

The protective layer preferably comprises a sheet shaped to conform to the shape of the lens. Preferably the sheet is made from PMMA. Preferably the sheet is thermoformed or injection moulded. Thermoforming is preferred as it is cheaper and enables large pieces, for example to accommodate multiple lenses, to be made in a single sheet. The multiple lenses can then be mounted on the underside of this sheet.

The invention also provides an advantageous method of fabrication comprising mounting the convex face of the lens to a transparent sheet. Preferably the lens is mounted to a shaped plastic sheet, the shape conforming to the shape of the lens. Preferably the sheet is shaped using either thermoforming or injection moulding. Preferably the lens is laminated to the sheet.

In one set of embodiments the laminating step comprises using a pressure-sensitive adhesive. In these embodiments the pressure-sensitive adhesive is conveniently applied to the convex face of the lens. The lens can then be pressed onto the sheet and held down to allow the adhesive to secure the lens to the sheet.

In another alternative set of embodiments the laminating step comprises using a UV curable glue. Preferably the glue is optically transparent. In these embodiments the sheet and/or lens is coated with the UV glue, e.g. using a spray coating or similar method. The lens and the sheet can then be pressed together and exposed to UV light to set the glue.

In a further alternative set of embodiments the laminating step comprises using a solvent. In these embodiments the sheet and/or lens is coated with the solvent. The lens and the sheet can then be pressed together allowing the surfaces to fuse.

Embodiments of lenses in accordance with the various aspects of the invention may be used in solar concentrator applications. For example, the lens may be used in conjunction with a suitable photovoltaic device placed at or near the lens focus to produce electricity from solar radiation. By way of example, a solar cell may be any one of moncrystalline silicon, polycrystalline silicon, amorphous silicon or a multijunction gallium arsenide. In some embodiments of such use, a secondary concentrator which uses reflectance or refraction may be placed at or near the focus of the lens so as to further concentrate the light onto the solar receiver.

In alternative applications, a thermal receiver may be placed at or near the focus of the lens and used in conjunction with a solar thermal energy system such as heating a solid plate or a working fluid. The heated plate or heated working fluid can be used ultimately to drive, for example, a Stirling Engine, a Rankine Cycle turbine, or a steam turbine.

Typically, the focus of the lens will be in a plane beneath and parallel to the plane containing the inner region of the lens. If the inner region of the lens is not flat, the plane containing the lens is defined to be the plane which contains the perimeter of the inner region. Hence the solar cell or thermal receiver will generally be placed in the plane beneath and parallel to the inner region of the lens at the focus of the lens.

Some embodiments of various aspects of the invention will now be described by way of example only, and with reference to the accompanying drawings, in which:

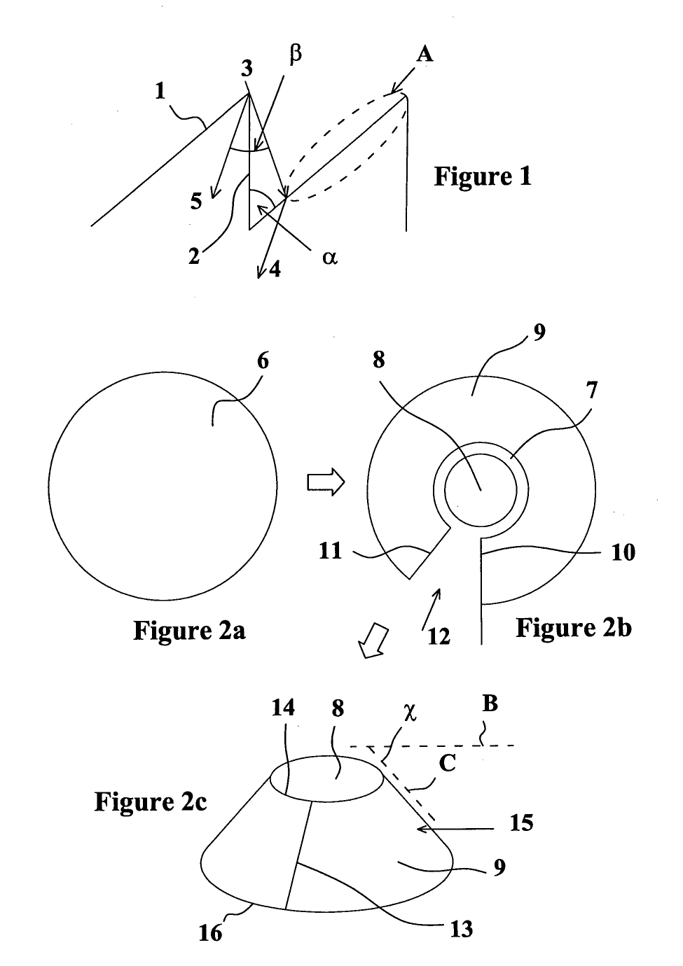

FIG. 1 is a diagram showing the light interaction with a prism of an inclined surface Fresnel lens;

FIG. 2(a) shows a disc of film used to manufacture a lens in accordance with an aspect of the invention;

FIG. 2(b) shows the disc at an intermediate stage of manufacturing the lens;

FIG. 2(c) shows the lens;

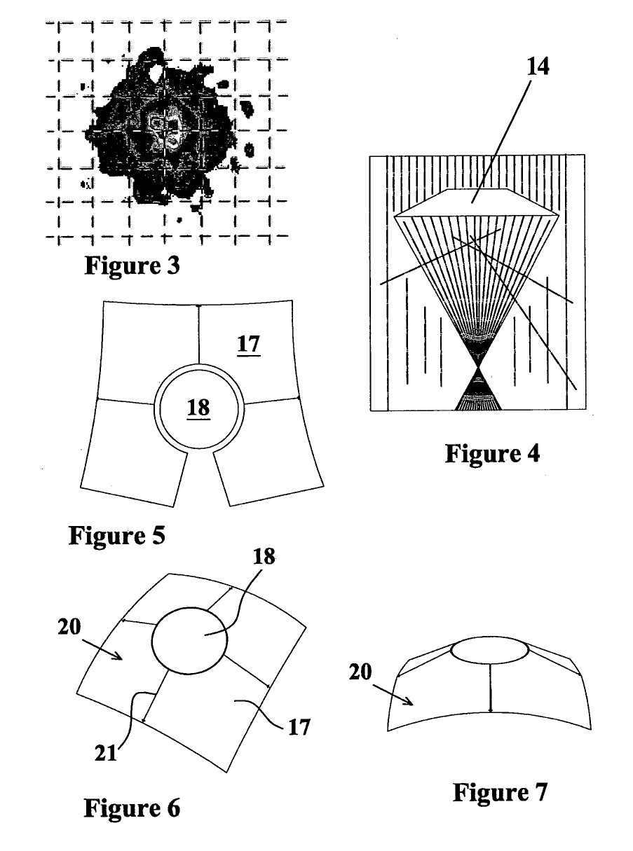

FIG. 3 shows the focal shape of the lens;

FIG. 4 shows the concentration ability of the lens;

FIG. 5 shows a portion of film used to manufacture another embodiment of lens in accordance with an aspect of the invention;

FIG. 6 is a top perspective view of the lens made from the portion of film shown in FIG. 5;

FIG. 7 is a front perspective view of the lens of FIG. 6;

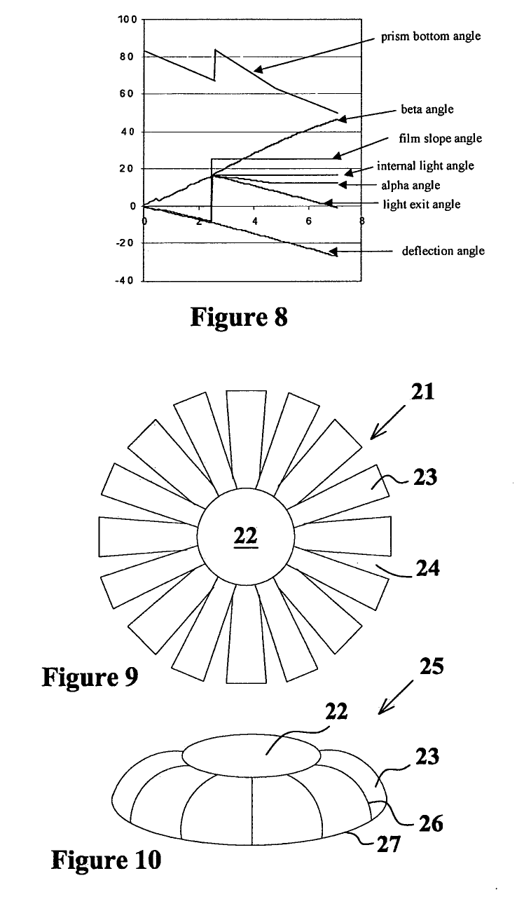

FIG. 8 illustrates the design parameters for a lens in accordance with an aspect of the invention;

FIG. 9 shows a piece of film used in the manufacture of another embodiment of lens in accordance with an aspect of the invention;

FIG. 10 shows the lens;

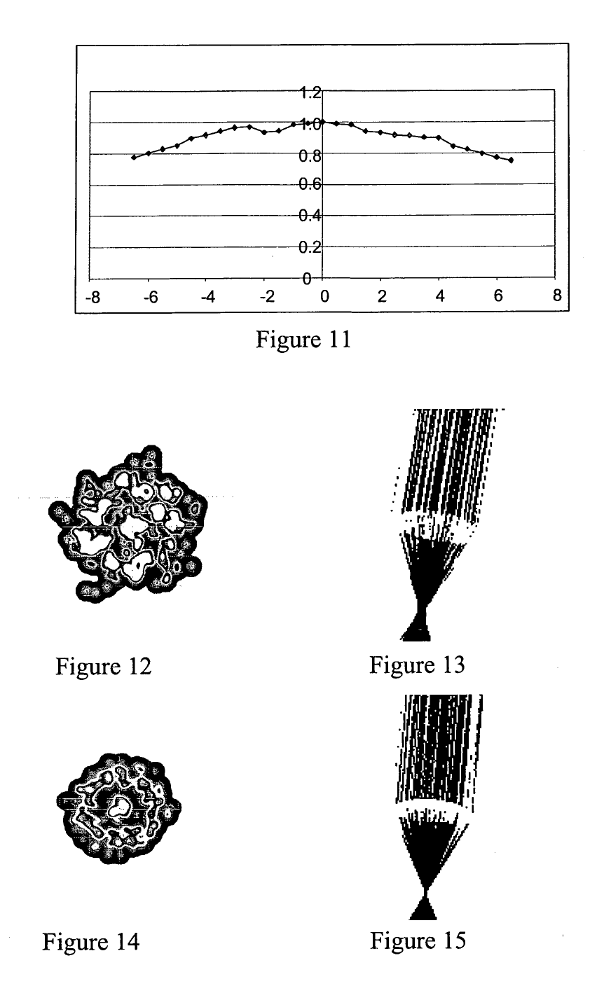

FIG. 11 shows the performance of a lens in accordance with FIG. 10;

FIG. 12 shows the focal shape of the lens;

FIG. 13 shows the concentration ability of the lens;

FIG. 14 shows the focal shape of a theoretical lens in accordance with the invention;

FIG. 15 shows the concentration ability of the theoretical lens;

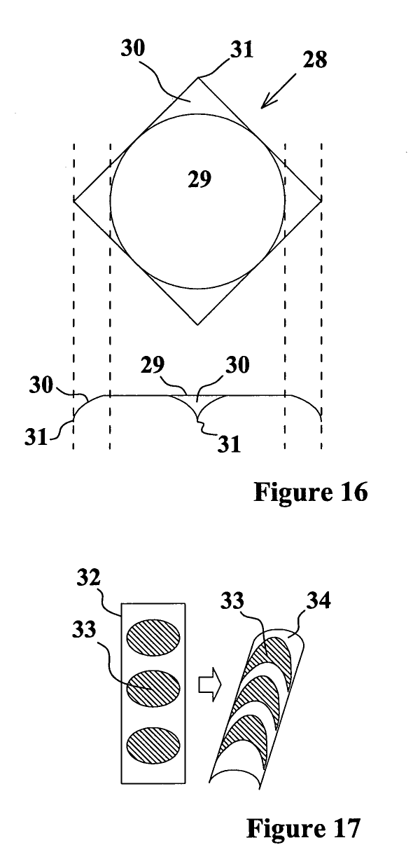

FIG. 16 shows a plan view and a front view of an alternative lens in accordance with the invention;

FIG. 17 shows the manufacture of lenses in accordance with another aspect of the invention;

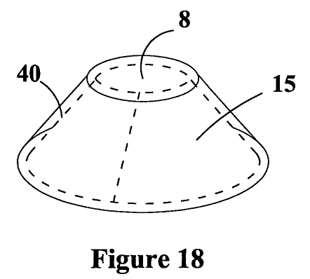

FIG. 18 shows the lens mounted beneath a protective layer; and

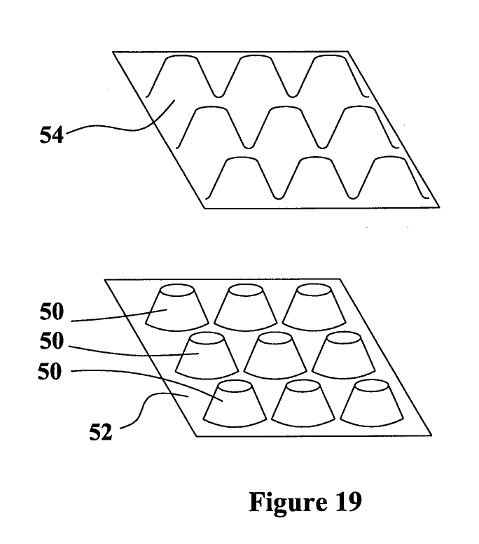

FIG. 19 shows an array of lenses mounted beneath a sheet.

Referring now in detail to FIG. 1, there is shown the light interaction with a Fresnel lens 1 made from thin film. The lens has a number of prisms 2 with prism angle α at the prism apex. The light is represented by arrows 3 and 4. The film is inclined with respect to the light direction by an angle β as shown between the arrow 3 and an arrow 5. It can be seen that only the section of the prism marked A interacts with the light, meaning that the light does not interact with the apex of the prism nor with the non-optical facet.

FIG. 2(a) shows a circular disc 6 of thin film Fresnel lens which has been cut from a sheet. As indicated in FIG. 2(b), this disc is cut so as to remove an annular portion, thus leaving an annular gap 7 between a central region 8 and an outer region 9. Cut lines 10 and 11 are made in the outer region 9, running from the circumference of the disc to the annular gap 7, and the section between the cut lines is removed to leave an outwardly tapering opening 12. As shown in FIG. 2(c), the outer region 9 is curved round and its ends joined together along a seam line 13. The central region 8 is joined to the outer region 9 by means of a circular seam line 14.

The resulting structure is a hollow truncated cone 15 of film, with a flat circular top 8 and an open, circular base 16. The film of the outer region is thus inclined to the horizontal plane of the central region 8 by an angle χ as indicated between the lines B and C. In a preferred embodiment, this angle χ is about 25°.

In one example of such a lens, the focal shape is as shown in FIG. 3 and the concentrating ability is as shown in FIG. 4, where there is 92% efficiency.

FIG. 5 shows a portion of film for use in a the manufacture of a modified type of lens. The comprises an outer region 17 and an inner region 18. The arrangement is similar to that of FIG. 2(b) but instead of the outer region being part of an annulus as would be the case when starting from a circular disc of film, it has been cut from a shape in the form of a distorted square. As shown in FIGS. 6 and 7, a structure 20 in the form of a truncated cone is formed by joining the ends of the outer region along a seam line 21 and also joining the flat central region 18 to the inclined outer region 17. In plan view, the structure is of square shape, with sides of about 10 cm. It is effectively a truncated circular cone, but with four extended portions each ending in a point.

FIG. 8 shows the design parameters for a truncated cone lens with an overall radius of about 7 cm, a flat central region of about 2.5 cm radius, an inclination angle of about 25°, and a focal length ratio of about 2, giving a focal length for the lens of about 14 cm. The Figure shows how the prism bottom angle, beta angle, alpha angle, internal light angle, light exit angle and deflection angle vary as a function of radial extent from the centre of the lens. The film slope angle is also shown: it is zero until the limit of the inner region, and then is constant at 25°. The prism bottom angle reduces over the inner region, and then jumps to its original value after the transition, then reducing steadily to the edge of the lens. The alpha angle is the angle of the facet, which is non-optical, and the beta angle is the angle of the beta facet, which will be the facet which deflects light through the desired angle by a process of refraction. In this example, the alpha angle has been kept as high as sensibly possible to open out the prisms. The goal with the alpha angle is to keep it between (and as far away as possible from) the internal light angle and the light exit angle thereby ensuring that it does not interact with any light lowering the lens efficiency.

In addition the inner flat Fresnel facet angles can be adjusted to avoid a central “hot spot” in the light focus.

FIG. 9 shows a piece of Fresnel lens film 21 which has been cut so as to define a circular central region 22 of 2 cm radius and sixteen radially extending segments 23 separated by gaps 24. The segments 23 increase in width towards their outer extent. As shown in FIG. 10, a dome shaped lens 25 with flat central region 22 is formed by joining the segments 23 together along their edges, as shown at 26, to provide a continuous circumference 27. The lens has the appearance of an upturned, flat bottomed dish, or a flat topped umbrella. In this embodiment the radius of the lens is about 7 cm.

This approach has several advantages, including the ability to produce arbitrary surface curvatures outside the central region 22, and therefore optimised designs. However, the total number of seams will degrade the overall lens performance and may increase manufacturing complexity. FIG. 11 shows the performance across the lens.

For such a lens 25, using in this case sixteen segments of film in a symmetrical arrangement—although other numbers of segments are possible—the expected focal shape would be a circular spot in the centre with symmetrical rings spread out. The total size would be limited by the edge width of every segment. The modelled actual focal shape of an example is as shown in FIG. 12. The expected focal shape for an ideal lens of this type made from thousands of segments would be a circular spot in the middle with limited spot size because the edge width of every segment is very small. FIG. 13 shows a modelled actual focal shape. FIG. 14 shows a modelled concentration ability for the lens with sixteen segments, and FIG. 15 shows the modelled concentration ability for the ideal lens with thousands of segments.

FIG. 16 shows an alternative arrangement in which a square portion of film 28 has four regions 29 adjacent corners 30 turned down at an angle, leaving a flat central region 31 which can be considered to approximate to a circle. In this embodiment only a relatively small part of the film is inclined.

FIG. 17 shows an alternative arrangement in which a portion of film 32 has a number of elliptical lenses 33 cut out, which are then curved over a part cylindrical, or approximately part cylindrical, former 34. The design of the prisms is such that each lens focuses to a point.

FIG. 18 shows a lens in the form of a truncated cone with a outer region 15 and a flat circular top 8 as shown in FIG. 2(c). In this embodiment the lens is mounted beneath a transparent plastic sheet 40, PMMA for example, which has been shaped using either thermoforming or injection moulding such that it conforms to the shape of the lens. The convex face of the lens is laminated to the concave side of the plastic sheet by using one of a number of methods, e.g. using a pressure sensitive adhesive, a UV curable glue, or a solvent.

The plastic sheet is thicker than the thickness of the lens in order to protect the lens from long term weathering and other physical damage. Typically the lens will be 75-300 micron thick and the plastic sheet 1-3 mm thick.

FIG. 19 shows an array of lenses 50, similar to the lens in FIG. 18, arranged above a sheet of solar cells 52. Each lens focuses light onto an individual cell. A continuous transparent plastic sheet 54 is shaped so that it conforms to the array of lenses and thus when it is placed over the lenses forms a protective layer to prevent damage to the lenses, e.g. from long term weathering.

In embodiments of the invention, flat microstructured optical film may be manufactured using a reel-to reel process in which a base film is coated with a transparent UV curable lacquer (resin) and the film exposed to UV light while compressed against a casting cylinder on which a reverse of the desired structure is present. The film should be transparent, resistant to weathering but have a high adhesion to the cured lacquer, for example being one of PMMA, such as Plexiglas™, or Grilamid™ UV enhanced nylon such as TR90UV. These casting drums can be made using a variety of processes familiar to those skilled in the art. As an example, a master mould is produced by using diamond cutting a circular flat piece spinning around is its centre on a precision cutting machine. The diamond tool can be moved in such a way that micro-prismatic features can be cut on the worked piece with the resulting grooves circularly symmetrical around the cutting centre. The precision cutting process can create a V groove at a desired radius and with desired facet angles.

In general, the flat film must be bent or folded to create the curved sections and this should be done in a simple way that integrates with manufacture of the modules in which such lenses are to be mounted. The designs of lenses should be consistent with the chosen folding pattern and with having their “master moulds” manufactured by standard or only slightly modified precision cutting machinery.

The design needs to specify the positions of the prism and the angle of the two facets: the alpha facet, which is non-optical, and the beta facet, which will be the facet which deflects light through the desired angle by a process of refraction.

In a flat Fresnel concentrating collimated light, as for a solar concentrator, the alpha facet is vertical. In a curved Fresnel the alpha facet has an angle chosen such that it lies between the angle of the light passing within the prism and the angle of the light exiting from the prism. In this way no light should interact with the alpha facet and in addition the light is kept away (to some degree at least) from the prism apex.

In all cases the curved focal Fresnel may first be designed using an appropriate design approach which selects, for each prism, the correct alpha and beta facet angles which:

1) Result in the light (at each end of the spectrum) being correctly deflected to lie within the desired target area;
2) Result in suitable colour mixing of the light within the desired target area;
3) Result in a reasonably even distribution of total light energies within the desired target area; and
4) Are as robust as possible again the small errors in: the values of the facet angles due to master mould machining inaccuracy; the surface slope angle resulting from either errors in manufacture or solar module mounting; the position of the target (which might be, for example a solar cell) in the x, y and z directions; and the pointing of the lens and collector correctly towards the sun.

Several factors need to be understood in order to model the optimal focal length which maximises, or generates a result with satisfactory performance, the concentrating ability of the prisms at the edge of the lens, which will be the ones which perform the worst.

Issues which need to be taken into account include:

1) The prisms cut on the film will vary from the desired angles within some error, generally experience has shown that these angles are accurate to +−0.1 degrees;
2) The film surface may not be held at the precisely correct angle with respect the incident light and the target—generally this is likely to be correct to within +−2 degrees or less;
3) The incident light will not be exactly aligned on the system, due to tracking errors, alignment issues, vibration and so on—generally it is anticipated that this is correct to around ±0.2 degrees;
4) The position of the target may not be exactly set at the correct depth, for example it may be within ±0.5 mm of the correct position;
5) The position of the target may not be set in precisely the right x, y position—in general there may be assumed an angular error of ±0.2 degrees; and
6) Chromatic aberration inherently limits the concentrating ability of a prism, since there is an inherent difference in the angles at which red and blue light emerge from the prism—in general it may be assumed that there is a range of refractive indices from 1.48 to 1.51.

The film needs to be placed on a shim to produce multiple versions of the lens. This “tiling out” should be done as efficiently as possible so as to minimise the loss of film.

To form the flat master mould, the lens profile needs to be altered from that for a flat lens. The area needs to be expanded to allow a section to be cut out from it, so that then conical surface can be formed, and result in the correct lens sizes. A small section between the central flat Fresnel region and the outer section needs to be filled in, and this section will be discarded. The overall size of the film portion the lens needs to be expanded to allow a suitable prismatic element to be tiled out. The outer parts of the film portion can be of any suitable profile, as they are not part of the lens and will be discarded.

In general, in embodiments of the invention the prism depths of the microprismatic Fresnel lens structure lie between about 10 and about 100 microns. Typically, the total thin film thickness (based film and prismatic feature combined) lies between about 50 and about 800 microns thick. The film may be manufactured using UV curing of optical lacquer coated on a base film and exposed when the lacquer is in contact with a suitable inverse microprismatic moulds or by other methods for mass manufacture of microoptical structures known to those skilled in the art. The base plastic film may contains a UV protectant chemical.

In embodiments of the invention, the appropriate choice of lens slope, whether provided by a linear profile or by a curved profile, ensures a better efficiency that would be achieved by continuing with a flat region to the edge of the lens.

It will be appreciated that references in this specification to a lens providing a point focus are not intended to imply that there is a perfect or near perfect point of focus. The intention is to distinguish over, for example, a line focus of the type that would be provided by a conventional cylindrical lens. The expression point focus thus covers focussing to an area.

1-35. (canceled)

36. A point focus thin film Fresnel lens comprising a substantially flat inner region including a surface arranged along a first plane and including at least one lens facet, and an outer region including at least one lens facet, the outer region projecting outwardly from the inner region and at a nonzero angle away from the first plane.

37. A lens as claimed in claim 36, wherein the inner region is circular.

38. A lens as claimed in claim 37, wherein the outer region extends completely around the inner region.

39. A lens as claimed in claim 36, wherein the outer region projects in a linear fashion away from the inner region.

40. A lens as claimed in claim 39, wherein the outer region projects at a substantially constant angle away from the inner region.

41. A lens as claimed in claim 40, wherein the outer region projects away from the inner region at a surface inclination angle in a range of from about 20° to about 35°.

42. A lens as claimed in claim 41, wherein the surface inclination angle is in a range of from about 22° to about 30°.

43. A lens as claimed in claim 39, in the form of a truncated cone.

44. A lens as claimed in claim 36, in the form of a truncated cone in which the inner region is circular and forms an apex of the truncated cone, and the outer region extends around an entire circumference of the inner region to form a wall of the truncated cone and is joined to the inner region.

45. A lens as claimed in claim 43, wherein the lens has a substantially square outline in plan view.

46. A lens as claimed in claim 36, wherein the outer region projects in a curved fashion away from the inner region.

47. A lens as claimed in claim 36, wherein the inner region is circular and the outer region extends around an entire circumference of the inner region to form a curved outer wall and is formed by a plurality of radially extending segments which extend from the inner region and are joined together along their edges whereby the outer region projects in a curved fashion away from the inner region.

48. A lens as claimed in claim 36, wherein the inner region has a radial extent of no more than about 45% of a total radius of the lens.

49. A lens as claimed in claim 48, wherein the inner region has a radial extent of from about 20% to about 45% of a total radius of the lens.

50. A lens as claimed in claim 49, wherein the inner region has a radial extent of from about 25% to about 35% of the total radius of the lens.

51. A lens as claimed in claim 36, wherein a ratio of focal length of the lens to radius of the lens is between about 1.5 and about 3.

52. A lens as claimed in claim 36 wherein the lens has a focus in a second plane beneath and substantially parallel to the first plane.

53. An assembly comprising a lens as claimed in claim 52, further comprising a solar cell or thermal receiver arranged in the second plane at the focus of the lens.

54. An assembly comprising a lens as claimed in claim 36, wherein the lens has a convex face and further comprises a transparent protective layer over the convex face.

55. An assembly as claimed in claim 54 wherein the protective layer is thicker than the thin film Fresnel lens.

56. An assembly as claimed in claim 54 wherein the protective layer has a thickness of from 1 mm to 3 mm.

57. An assembly as claimed in claim 54 wherein the protective layer has a shape that conforms to the convex face of the lens.

58. An assembly as claimed in claim 54 wherein the protective layer comprises a continuous transparent plastic sheet.

59. An assembly as claimed in claim 58 wherein the sheet comprises PMMA.

60. An assembly as claimed in claim 58 wherein the sheet is thermoformed or injection molded.

61. A method of manufacturing a lens as claimed in claim 43, wherein a portion of thin Fresnel lens film is provided with an annular cut to define a circular inner region separated from an outer region, an inwardly tapering cut is provided from the periphery of the outer region to the annular cut, the sides of the inwardly tapering cut are joined to together to form the wall of a truncated cone, and the outer region is joined to the inner region whereby the inner region forms the apex of the truncated cone.

62. A method of manufacturing a lens as claimed in claim 46, wherein a circular portion of thin Fresnel lens film is provided with a plurality of circumferentially spaced cut outs extending from the periphery of a circular inner region to the periphery of the film portion, the cut outs tapering inwardly from the periphery of the film portion to the periphery of the central region and defining radially extending film segments, and adjacent segments are joined together along their edges so that the segments define an outer region which extends around the entire inner region and which projects in a curved fashion away from the plane of the inner region.

63. A method of making a lens as claimed in claim 36, wherein a portion of thin Fresnel lens film has a polygonal shape, and corners portions are bent away from the plane of the polygon to provided outer regions which extend at an angle away from the plane of an inner region defined by the remainder of the film portion.

64. A method of manufacturing an assembly as claimed in claim 54 comprising mounting the convex face of the lens to a transparent sheet.

65. A method as claimed in claim 64 wherein the lens is mounted to a shaped plastic sheet having a shape that conforms to the convex face of the lens.

66. A method as claimed in claim 55 wherein the plastic sheet is shaped using at least one of thermoforming and injection molding.

67. A method as claimed in claim 64 comprising laminating the lens to the sheet.

68. An assembly comprising a lens as claimed in claim 36, further comprising a secondary concentrator placed at or near a focus of the lens.

69. A solar thermal energy system comprising a lens as claimed in claim 36, and a thermal receiver placed at or near a focus of the lens.

70. A solar thermal energy system as claimed in claim 69 wherein the thermal receiver comprises at least one of a working fluid and a solid plate.

71. An assembly as claimed in claim 53, wherein the lens has a convex face and further comprises a transparent protective layer over the convex face of the lens

72. A lens as claimed in claim 36, wherein at least one of the inner region and the outer region comprises a plurality of lens facets.
